(19) United States
(12) Patent Application Publication
(10) Pub. No.: US 2021/0200211 A1
(43) Pub. Date: Jul. 1, 2021

(54) METHOD OF GENERATING BACK-UP TRAJECTORIES FOR SELF-DRIVING VEHICLES DURING EMERGENCY

(71) Applicants: Baidu USA LLC, Sunnyvale, CA (US); Baidu.com Times Technology (Beijing) Co., Ltd., Beijing (CN)

(72) Inventors: XIN XU, Beijing (CN); FAN ZHU, Sunnyvale, CA (US)

(21) Appl. No.: 16/732,033

(22) Filed: Dec. 31, 2019

(51) Int. Cl. G05D 1/00; G05D 1/02

(52) U.S. Cl. CPC G05D 1/0088; G05D 2201/0213; G05D 1/0221; G05D 1/0077

(57) ABSTRACT

According to various embodiments, described herein are systems and methods for using backup trajectories to ensure the safety of the ADV. The ADV can implement an algorithm that stores a trajectory generated for each planning cycle. Once a new planning cycle begins, the ADV can first attempt to generate a trajectory; if a trajectory is successfully generated, the ADV can replace the stored trajectory with this newly generated trajectory. If a trajectory is not successfully generated during the new planning cycle due to software failures, the ADV can immediately restore the previously stored trajectory, and project the ADV onto this trajectory. As a result, the ADV can still have a functional trajectory that has been proved to be safe during the previous planning cycle. In one embodiment, the trajectory is a reference line, and can be generated when a corresponding planning cycle starts or any time during the planning cycle.

### TECHNICAL FIELD

Embodiments of the present disclosure relate generally to operating autonomous driving vehicles. More particularly, embodiments of the disclosure relate to back-up trajectory generation for use in emergency.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers. Motion planning and control are critical operations in autonomous driving. Particularly, trajectory planning is a critical component in an autonomous driving system. Conventional trajectory planning techniques rely heavily on high-quality reference lines, which are guidance paths, e.g., a center line of a road, for autonomous driving vehicles, to generate stable trajectories.

However, sometimes autonomous driving vehicles may fail to generate a feasible trajectory for the vehicle due to special driving scenarios or temporary abrupt changes in sensor data. Such a failure may have serious consequences, for example, causing the vehicle to suddenly stop or behave unpredictably.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous vehicle according to one embodiment.

FIGS. 3A-3B are block diagrams illustrating an example of a perception and planning system used with an autonomous vehicle according to one embodiment.

FIG. 4 illustrates an example system for generating a backup trajectory in accordance with an embodiment.

FIG. 5 illustrates projecting an ADV to a backup trajectory in accordance with an embodiment.

FIG. 6 is a flow diagram illustrating an example process of generating a backup trajectory in accordance with an embodiment

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to various embodiments, described herein are systems and methods for using backup trajectories to ensure the safety of the ADV. The ADV can implement an algorithm that stores a trajectory generated for each planning cycle. Once a new planning cycle begins, the ADV can first attempt to generate a trajectory; if a trajectory is successfully generated, the ADV can replace the stored trajectory with this newly generated trajectory. If a trajectory is not successfully generated during the new planning cycle due to software failures, the ADV can immediately restore the previously stored trajectory, and project the ADV onto this trajectory. As a result, the ADV can still have a functional trajectory that has been proved to be safe during the previous planning cycle. In one embodiment, the trajectory is a reference line, and can be generated when a corresponding planning cycle starts or any time during the planning cycle.

In one embodiment, an exemplary method includes the following operations: storing the trajectory in a data structure as a backup trajectory in response to generating a trajectory for the ADV during a first planning cycle; controlling the ADV based on the trajectory for the first planning cycle; detecting that the ADV fails to generate a trajectory during a second planning cycle; retrieving the backup trajectory from the data structure; and controlling the ADV based on the retrieved backup trajectory for the second planning cycle.

In one embodiment, the data structure is a linked list, wherein each node of the linked list stores a reference point on the trajectory. The first planning cycle and the second planning cycle are consecutive. The method further includes detecting that the ADV fails to generate a trajectory during a third planning cycle, which is consecutive with the second planning cycle.

In one embodiment, the failure to generate the trajectory during the second and the fourth planning cycles is due to one or more abrupt changes in sensor data. When the ADV fails to generate a trajectory for two consecutive planning cycles, the ADV may activate a sensor failure handling module to switch the ADV from driving in the world coordinate system to a local coordinate system. In one embodiment, the world coordinate system refers to a coordinate system in which that enables every location on Earth to be specified by a set of numbers, letters or symbols. The local or relative coordinate system, on the other hand, is a coordinate system that is relative to a current location of the ADV.

In one embodiment, controlling the ADV using the retrieved backup trajectory further includes: calculating a current position of the ADV during the second planning cycle relative to the retrieved backup trajectory; and using the current position as a new original starting point with respect to the retrieved backup trajectory. The current position of the ADV is calculated using sensor data.

The above summary does not include an exhaustive list of all aspects of the present invention. It is contemplated that the invention includes all devices, computer media, and methods that can be practiced from all suitable combinations of the various aspects summarized above, and also those disclosed in the Detailed Description below. The other functions and advantages will be apparent from the accompanying drawings and from the detailed description that follows.

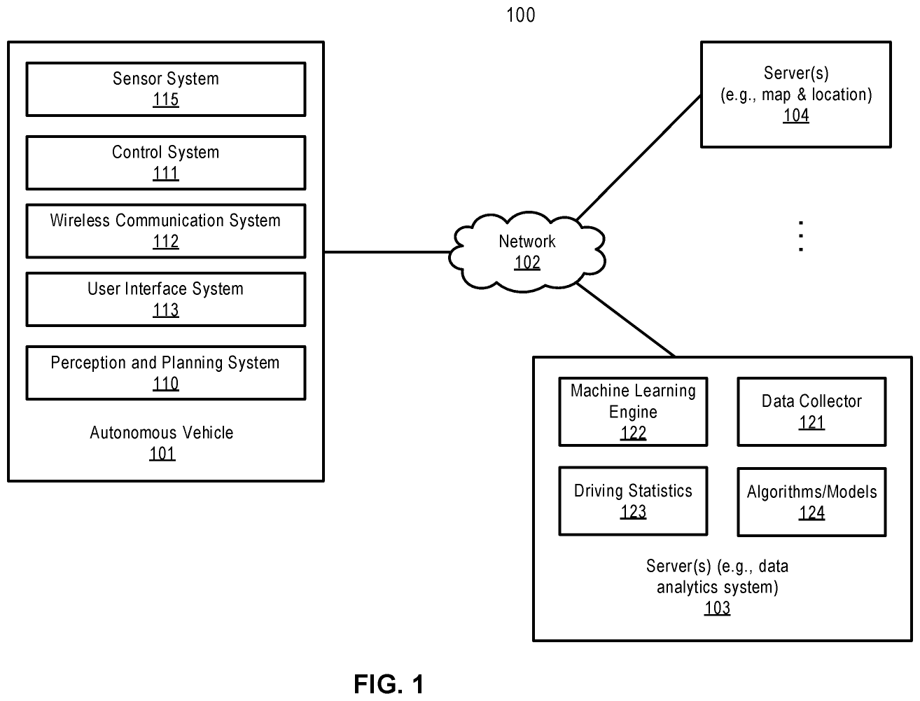

FIG. 1 is a block diagram illustrating an autonomous vehicle network configuration according to one embodiment of the disclosure. Referring to FIG. 1, network configuration 100 includes autonomous vehicle 101 that may be communicatively coupled to one or more servers 103-104 over a network 102. Although there is one autonomous vehicle shown, multiple autonomous vehicles can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) severs, or location servers, etc.

An autonomous vehicle refers to a vehicle that can be configured to in an autonomous mode in which the vehicle navigates through an environment with little or no input from a driver. Such an autonomous vehicle can include a sensor system having one or more sensors that are configured to detect information about the environment in which the vehicle operates. The vehicle and its associated controller(s) use the detected information to navigate through the environment. Autonomous vehicle 101 can operate in a manual mode, a full autonomous mode, or a partial autonomous mode.

In one embodiment, autonomous vehicle 101 includes, but is not limited to, perception and planning system 110, vehicle control system 111, wireless communication system 112, user interface system 113, and sensor system 115. Autonomous vehicle 101 may further include certain common components included in ordinary vehicles, such as, an engine, wheels, steering wheel, transmission, etc., which may be controlled by vehicle control system 111 and/or perception and planning system 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

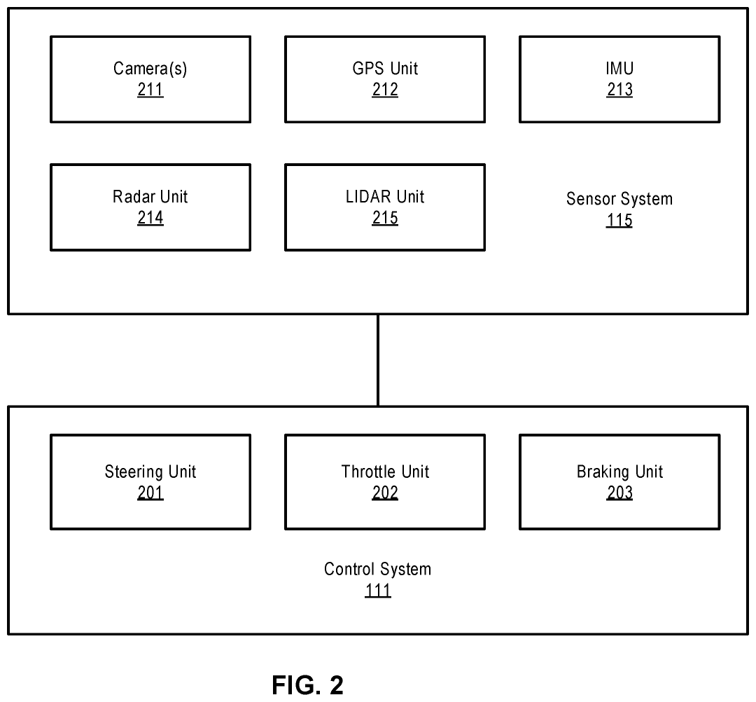

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the autonomous vehicle. IMU unit 213 may sense position and orientation changes of the autonomous vehicle based on inertial acceleration. Radar unit 214 may represent a system that utilizes radio signals to sense objects within the local environment of the autonomous vehicle. In some embodiments, in addition to sensing objects, radar unit 214 may additionally sense the speed and/or heading of the objects. LIDAR unit 215 may sense objects in the environment in which the autonomous vehicle is located using lasers. LIDAR unit 215 could include one or more laser sources, a laser scanner, and one or more detectors, among other system components. Cameras 211 may include one or more devices to capture images of the environment surrounding the autonomous vehicle. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn control the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between autonomous vehicle 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyword, a touch screen display device, a microphone, and a speaker, etc.

Some or all of the functions of autonomous vehicle 101 may be controlled or managed by perception and planning system 110, especially when operating in an autonomous driving mode. Perception and planning system 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, perception and planning system 110 may be integrated with vehicle control system 111.

For example, a user as a passenger may specify a starting location and a destination of a trip, for example, via a user interface. Perception and planning system 110 obtains the trip related data. For example, perception and planning system 110 may obtain location and route information from an MPOI server, which may be a part of servers 103-104. The location server provides location services and the MPOI server provides map services and the POIs of certain locations. Alternatively, such location and MPOI information may be cached locally in a persistent storage device of perception and planning system 110.

While autonomous vehicle 101 is moving along the route, perception and planning system 110 may also obtain real-time traffic information from a traffic information system or server (TIS). Note that servers 103-104 may be operated by a third party entity. Alternatively, the functionalities of servers 103-104 may be integrated with perception and planning system 110. Based on the real-time traffic information, MPOI information, and location information, as well as real-time local environment data detected or sensed by sensor system 115 (e.g., obstacles, objects, nearby vehicles), perception and planning system 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either autonomous vehicles or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, for example, algorithms 124 may include an optimization method to optimize path planning and speed planning. The optimization method may include a set of cost functions and polynomial functions to represent path segments or time segments. These functions can be uploaded onto the autonomous driving vehicle to be used to generate a smooth path at real time.

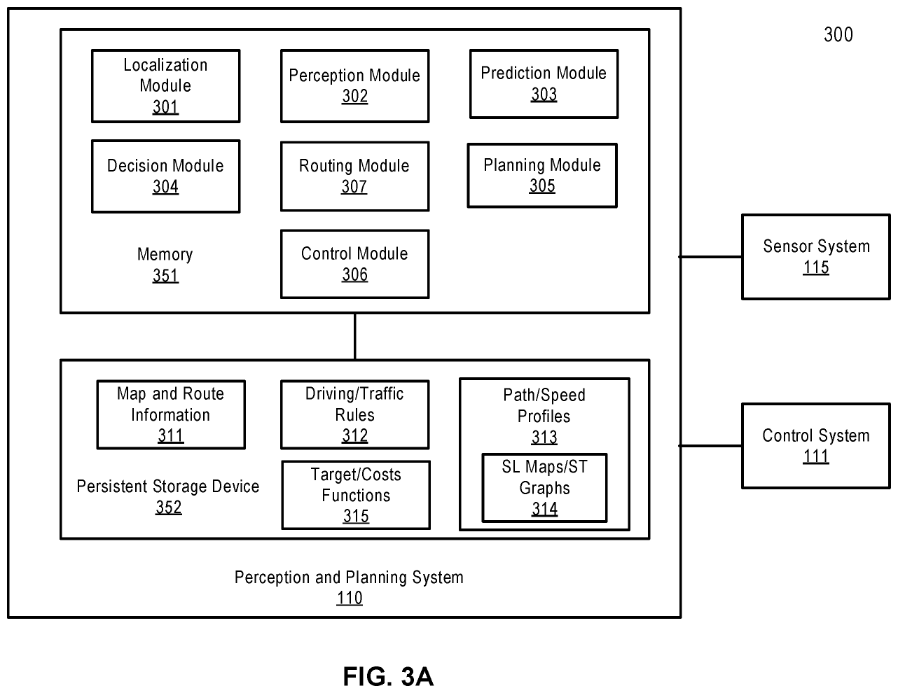

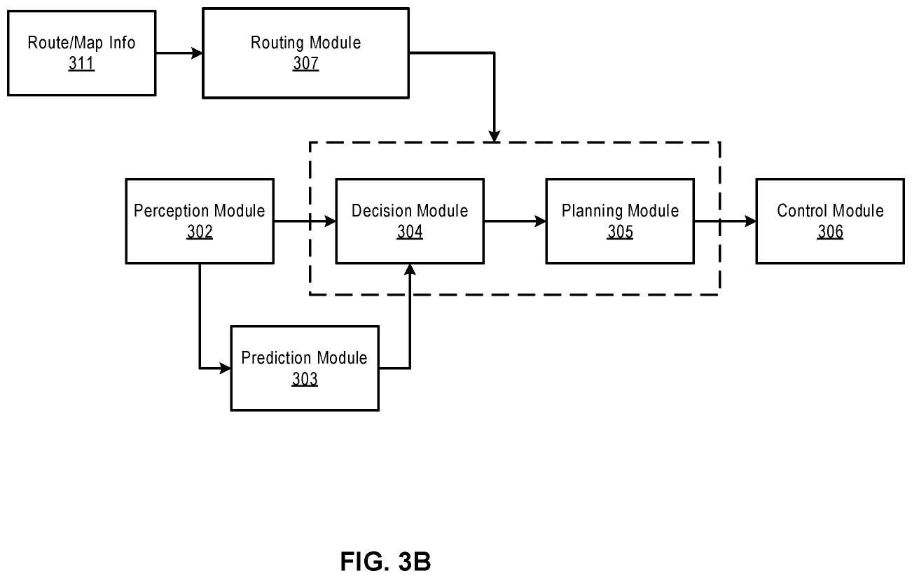

FIGS. 3A and 3B are block diagrams illustrating an example of a perception and planning system used with an autonomous vehicle according to one embodiment. System 300 may be implemented as a part of autonomous vehicle 101 of FIG. 1 including, but is not limited to, perception and planning system 110, control system 111, and sensor system 115. Referring to FIGS. 3A-3B, perception and planning system 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module. For example, decision module 304 and planning module 305 may be integrated as a single module.

Localization module 301 determines a current location of autonomous vehicle 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of autonomous vehicle 300, such as map and route information 311, to obtain the trip related data. For example, localization module 301 may obtain location and route information from a location server and a map and POI (MPOI) server. A location server provides location services and an MPOI server provides map services and the POIs of certain locations, which may be cached as part of map and route information 311. While autonomous vehicle 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration (e.g., straight or curve lanes), traffic light signals, a relative position of another vehicle, a pedestrian, a building, crosswalk, or other traffic related signs (e.g., stop signs, yield signs), etc., for example, in a form of an object.

Perception module 302 may include a computer vision system or functionalities of a computer vision system to process and analyze images captured by one or more cameras in order to identify objects and/or features in the environment of autonomous vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Based on a decision for each of the objects perceived, planning module 305 plans a path or route for the autonomous vehicle, as well as driving parameters (e.g., distance, speed, and/or turning angle). That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 miles per hour (mph), then change to a right lane at the speed of 25 mph.

Based on the planning and control data, control module 306 controls and drives the autonomous vehicle, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, and turning commands) at different points in time along the path or route.

In one embodiment, the planning phase is performed in a number of planning cycles, also referred to as command cycles, such as, for example, in every time interval of 100 milliseconds (ms). For each of the planning cycles or command cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the autonomous vehicle. For example, the navigation system may determine a series of speeds and directional headings to effect movement of the autonomous vehicle along a path that substantially avoids perceived obstacles while generally advancing the autonomous vehicle along a roadway-based path leading to an ultimate destination. The destination may be set according to user inputs via user interface system 113. The navigation system may update the driving path dynamically while the autonomous vehicle is in operation. The navigation system can incorporate data from a GPS system and one or more maps so as to determine the driving path for the autonomous vehicle. Decision module 304/planning module 305 may further include a collision avoidance system or functionalities of a collision avoidance system to identify, evaluate, and avoid or otherwise negotiate potential obstacles in the environment of the autonomous vehicle. For example, the collision avoidance system may effect changes in the navigation of the autonomous vehicle by operating one or more subsystems in control system 111 to undertake swerving maneuvers, turning maneuvers, braking maneuvers, etc. The collision avoidance system may automatically determine feasible obstacle avoidance maneuvers on the basis of surrounding traffic patterns, road conditions, etc. The collision avoidance system may be configured such that a swerving maneuver is not undertaken when other sensor systems detect vehicles, construction barriers, etc. in the region adjacent the autonomous vehicle that would be swerved into. The collision avoidance system may automatically select the maneuver that is both available and maximizes safety of occupants of the autonomous vehicle. The collision avoidance system may select an avoidance maneuver predicted to cause the least amount of acceleration in a passenger cabin of the autonomous vehicle.

Routing module 307 can generate reference routes, for example, from map information such as information of road segments, vehicular lanes of road segments, and distances from lanes to curb. A reference route is generated by generating reference points along the reference route. For example, for a vehicular lane, routing module 307 can connect midpoints of two opposing curbs or extremities of the vehicular lane provided by a map data. Based on the midpoints and machine learning data representing collected data points of vehicles previously driven on the vehicular lane at different points in time, routing module 307 can calculate the reference points by selecting a subset of the collected data points within a predetermined proximity of the vehicular lane and applying a smoothing function to the midpoints in view of the subset of collected data points. Based on reference points or lane reference points, routing module 307 may generate a reference line by interpolating the reference points such that the generated reference line is used as a reference line for controlling ADVs on the vehicular lane.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

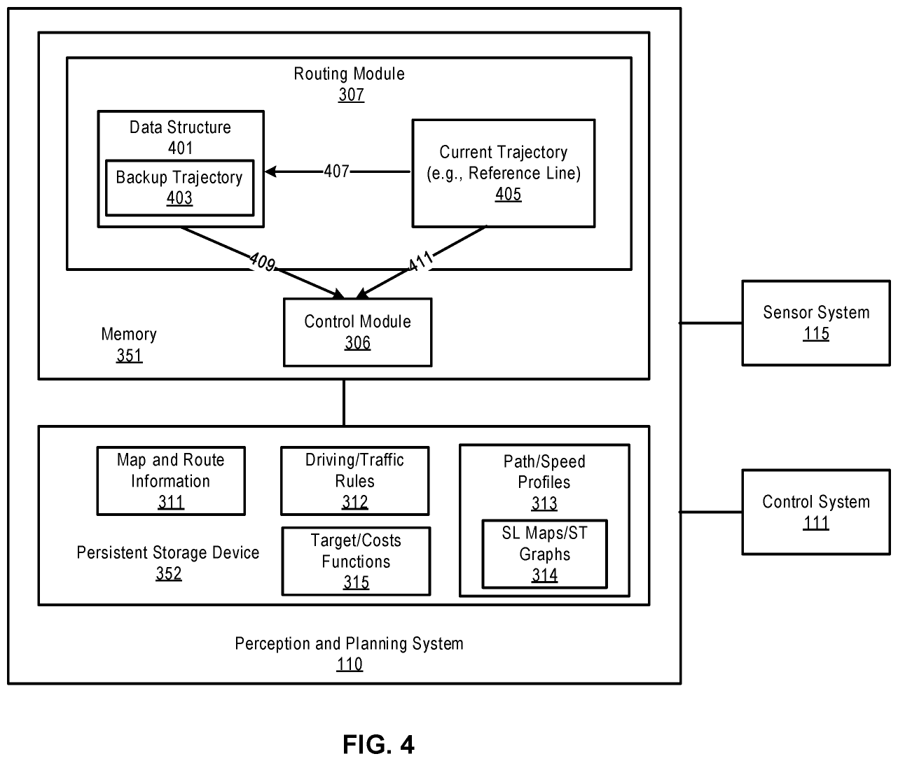

FIG. 4 illustrates an example system for generating a backup trajectory in accordance with an embodiment. As shown in FIG. 4, the routing module 307 can include a data structure 401, which in one implementation can be a linked list. The routing module 307 can generate a current trajectory 405 once a new planning cycle starts.

The current trajectory 405 can be a reference line, which can be smoothed using one or more smoothers before being used for controlling the ADV. In one embodiment, the raw reference line can be smoothed using a Quadratic programming (QP) spline smoother and/or a spiral smoother.

In one implementation of using both the QP spline smoother and the spiral smoother, the reference can be smoothed first using the Quadratic programming (QP) spline smoother to generate a smoothed reference line. The routing module 307 can then identify one or more segments on the smoothed reference line, each of the identified reference line segments including a curvature that exceeds a predetermined size. The routing module 307 can then smooth each of the one or more identified reference line segments using the spiral smoother, including optimizing each identified curvature in view of a set of constraints, such that an output of the objective function reaches a minimum value while the set of constraints are satisfied.

In one embodiment, for each planning cycle, the routing module 307 or another module of the ADV can perform a number of operations to generate a trajectory (e.g., a reference line) based on the ADV's geographical location and driving direction. If a trajectory is successfully generated for that planning cycle, the backup trajectory 403 in the data structure can be replaced with the newly generated trajectory. Therefore, the backup trajectory 403 in the data structure is constantly or periodically updated with the newly generated trajectory.

In one embodiment, the data structure 401 can be a linked list, and each node of the linked list can store one reference point and its associated information on the trajectory. When a trajectory cannot be successfully generated, the control module 306 can restore the previous trajectory calculated during the immediately preceding planning cycle, project the ADV onto this restored trajectory, and use the restored trajectory to control the ADV. For example, an optimization of a trajectory fails to converge to generate a trajectory. Alternatively, some perception data is not complete due to sensors' failure.

In one embodiment, the control module 306 can project the ADV to the backup trajectory. To do that, the control module first can calculate the ADV's current position relative to the previous trajectory. The current position can be calculated at the beginning of a planning cycle for which the ADV fails to generate a trajectory. Since the ADV may already have moved forward during the planning cycle for which the ADV fails to generate a trajectory, the current position of the ADV may not be the original position of the ADV when the previous planning cycle started. The current position of the ADV can be obtained from sensors and used as the new original point with respect to the restored trajectory. Once obtaining the current position of the ADV, the control module can treat the ADV as having deviated to that point from the restored trajectory, and can issues driving commands as needed to move the ADV back to the restored trajectory based on the current positon of the ADV, the driving environment, and the restored trajectory.

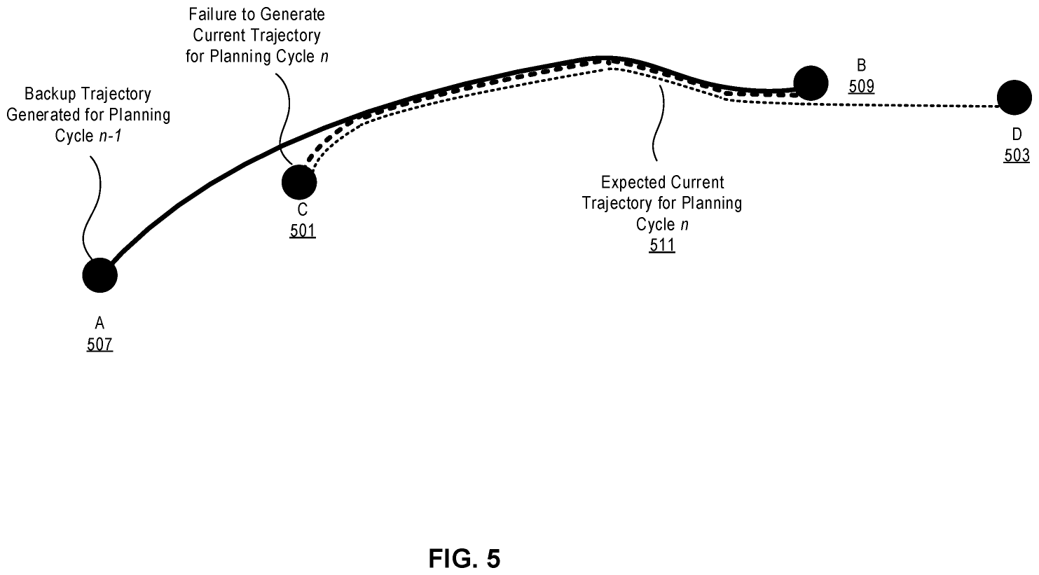

FIG. 5 illustrates projecting an ADV to a backup trajectory in accordance with an embodiment. In this illustration, a backup trajectory represented by point A 507 and point B 509 can be restored from a data structure (e.g., a linked list) in the event of a trajectory generation failure for the ADV in the next planning cycle.

As shown in FIG. 5, in a previous planning cycle (i.e. planning cycle n−1), a trajectory was successfully generated and saved to a data structure. In the next planning cycle (i.e., planning cycle n), the ADV fails to generate a trajectory. The ADV can restore the trajectory from the data structure, and use the restored trajectory to control the ADV.

In one embodiment, when such a failure occurs, the ADV may have moved forward to point C 501, which may not be on the restored trajectory. The control module 306 can treat point C 501 as the new position of the ADV with respective to the restored trajectory, and guide the ADV back to the restored trajectory. Thereafter, the ADV can follow the trajectory represented by point C 501 and point 509.

The control module 306 may not realize that a trajectory generation failure has occurred. From the perspective of the control 306, the ADV has deviated from a trajectory (i.e. the restored trajectory) to point C 501. The control module 306 therefore can issue appropriate driving commands to guide the ADV back to the restored trajectory.

As further shown in FIG. 5, an expected trajectory represented by point C 501 and point D 503 would be substantially similar to the restored trajectory, as the driving environment of the ADV would not likely change much from one planning cycle to the next planning cycle.

In one embodiment, if the ADV fails to generate a trajectory again in the planning cycle n+1, the ADV may determine that the failures may be caused by sensor failures, rather than by software failures to generate a feasible solution due to abrupt sensor data changes.

In other embodiments, the ADV fails to generate a feasible trajectory due to some particular driving scenarios, which may cause a failure in meeting one or more constraints required for trajectory generation. In generating a trajectory, the ADV may perform a number of mathematical calculations to avoiding obstacles, and to satisfy one or more constraints on curvature, and one or more constraints on heading rate change. Sometimes, the ADV may end up in a situation where the ADV cannot meet one or more constraints for generating a trajectory. For example, in some sharp corners, the ADV may not always perfectly follow the initial trajectory, and therefore has to make a larger turn to get around the corner. In such a scenario, the ADV may fail to generate a trajectory since it cannot meet some constrains on curvatures due to the larger turn.

In one embodiment, when a trajectory is not successfully generated in two or more consecutive planning cycles, the ADV may activate a sensor failure handling module to switch the ADV from driving in the world coordinate system to a local coordinate system.

In one embodiment, after the coordinate switch, the ADV may activate functions for camera-based obstacle detection and lane mark detection, which would enable the ADV to drive safely in the local coordinate system until human dis-engagement or until the ADV is parked along a road side.

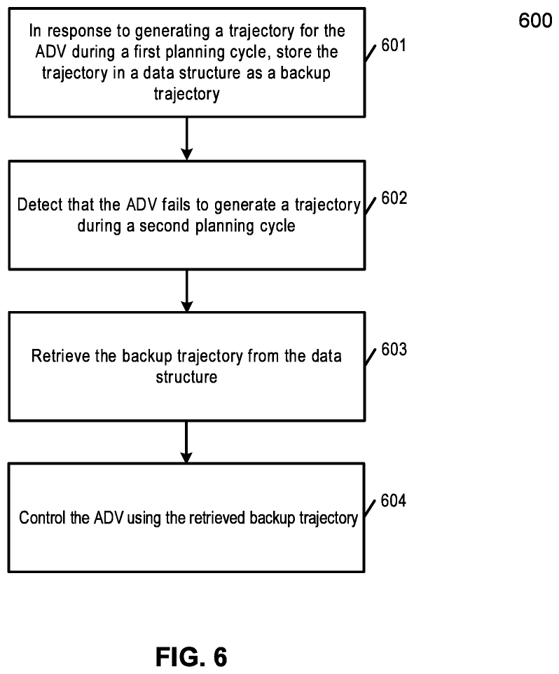

FIG. 6 is a flow diagram illustrating an example process 600 of generating a backup trajectory in accordance with an embodiment. In one embodiment, process 600 may be performed by processing logic which may include one or more of the planning module 305 or control module 306 as shown FIG. 3A, FIG. 4, and FIG. 5.

Referring to FIG. 6, in operation 601, the processing stores a trajectory generated in a first planning cycle to a data structure as a backup trajectory. The trajectory can be generated when the first planning cycle starts. In operation 602, the process logic detects that the ADV fails to generate a trajectory during a second planning cycle. In operation 603, the processing logic retrieves the backup trajectory from the data structure. In operation 604, the processing logic controls the ADV using the retrieved backup trajectory.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

All of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for operating an autonomous driving vehicle (ADV), the method comprising:
in response to generating a trajectory for the ADV during a first planning cycle, storing the trajectory in a data structure as a backup trajectory;
controlling the ADV based on the trajectory for the first planning cycle;
detecting that the ADV fails to generate a trajectory during a second planning cycle;
retrieving the backup trajectory from the data structure; and
controlling the ADV based on the retrieved backup trajectory for the second planning cycle.

2. The method of claim 1, wherein the data structure is a linked list, wherein each node of the linked list stores a reference point on the trajectory.

3. The method of claim 1, wherein the failure to generate the trajectory during the second planning cycle is due to one or more abrupt changes in sensor data.

4. The method of claim 1, wherein the first planning cycle and the second planning cycle are consecutive planning cycles.

5. The method of claim 1, wherein the ADV is configured to generate a trajectory when each of the first planning cycle and the second planning cycle starts.

6. The method of claim 1, wherein controlling the ADV using the retrieved backup trajectory further includes:
calculating a current position of the ADV during the second planning cycle relative to the retrieved backup trajectory; and
using the current position as a new original starting point with respect to the retrieved backup trajectory.

7. The method of claim 5, wherein the current position of the ADV is calculated using sensor data.

8. The method of claim 6, further comprising:
detecting that the ADV fails to generate a trajectory during a third planning cycle,
wherein the third planning cycle and the second planning cycle are consecutive; and
activating a sensor failure handling module to switch the ADV from having in the world coordinate system to a local coordinate system.

9. A non-transitory machine-readable medium having instructions stored therein for operating an autonomous driving vehicle (ADV), the instructions, when executed by a processor, causing the processor to perform operations, the operations comprising:
in response to generating a trajectory for the ADV during a first planning cycle, storing the trajectory in a data structure as a backup trajectory;
controlling the ADV based on the trajectory for the first planning cycle;
detecting that the ADV fails to generate a trajectory during a second planning cycle;
retrieving the backup trajectory from the data structure; and
controlling the ADV based on the retrieved backup trajectory for the second planning cycle.

10. The non-transitory machine-readable medium of claim 9, wherein the data structure is a linked list, wherein each node of the linked list stores a reference point on the trajectory.

11. The non-transitory machine-readable medium of claim 9, wherein the failure to generate the trajectory during the second planning cycle is due to one or more abrupt changes in sensor data.

12. The non-transitory machine-readable medium of claim 9, wherein the first planning cycle and the second planning cycle are consecutive.

13. The non-transitory machine-readable medium of claim 9, wherein the ADV is configured to generate a trajectory when each of the first planning cycle and the second planning cycle starts.

14. The non-transitory machine-readable medium of claim 9, wherein controlling the ADV using the retrieved backup trajectory further includes:
calculating a current position of the ADV during the second planning cycle relative to the retrieved backup trajectory; and
using the current position as a new original starting point with respect to the retrieved backup trajectory.

15. The non-transitory machine-readable medium of claim 14, wherein the current position of the ADV is calculated using sensor data.

16. The non-transitory machine-readable medium of claim 15, the operations further comprising:
detecting that the ADV fails to generate a trajectory during a third planning cycle,
wherein the third planning cycle and the second planning cycle are consecutive; and
activating a sensor failure handling module to switch the ADV from having in the world coordinate system to a local coordinate system.

17. A data processing system, comprising:
a processor; and
a memory coupled to the processor to store instructions, which when executed by the processor, cause the processor to perform operations, the operations including in response to generating a trajectory for the ADV during a first planning cycle,
storing the trajectory in a data structure as a backup trajectory,
controlling the ADV based on the trajectory for the first planning cycle,
detecting that the ADV fails to generate a trajectory during a second planning cycle,
retrieving the backup trajectory from the data structure, and
controlling the ADV based on the retrieved backup trajectory for the second planning cycle.

18. The system of claim 17, wherein the data structure is a linked list, wherein each node of the linked list stores a reference point on the trajectory.

19. The system of claim 17, wherein the failure to generate the trajectory during the second planning cycle is due to one or more abrupt changes in sensor data.

20. The system of claim 17, wherein the first planning cycle and the second planning cycle are consecutive.
